(19) United States
(12) Patent Application Publication
(10) Pub. No.: US 2016/0164910 A1
(43) Pub. Date: Jun. 9, 2016

(54) Processing Method and Apparatus for Preventing Packet Attack

(71) Applicant: Huawei Technologies Co., Ltd., Shenzhen (CN)

(72) Inventor: Xiaohu Tang, Nanjing (CN)

(21) Appl. No.: 14/962,618

(22) Filed: Dec. 8, 2015

(30) Foreign Application Priority Data
Dec. 8, 2014 (CN) 201410746239.3

(51) Int. Cl. H04L 29/06; H04L 12/26

(52) U.S. Cl. CPC H04L 63/1441; H04L 43/0894; H04L 43/16; H04L 63/101

(57) ABSTRACT

A processing method and apparatus for preventing a packet attack. A network protocol negotiation status of a port of a network device is monitored; a port that succeeds in network protocol negotiation is set to a trusted port, a protocol packet is selected, according to a first access control list (ACL), from packets received by the trusted port, and a rate at which the protocol packet is sent to a central processing unit (CPU) is limited to a first committed access rate (CAR); a port that fails in network protocol negotiation is set to an untrusted port, a protocol packet is selected, according to a second ACL, from packets received by the untrusted port, and a rate at which the protocol packet is sent to the CPU is limited to a second CAR. Configuration accuracy of the trusted port and the untrusted port is improved, and packet attack is prevented.

### CROSS-REFERENCE TO RELATED APPLICATION

This application claims priority to Chinese Patent Application No. 201410746239.3, filed on Dec. 8, 2014, which is hereby incorporated by reference in its entirety.

### TECHNICAL FIELD

This application relates to the field of network technologies, and in particular, to a processing method and apparatus for preventing a packet attack.

### BACKGROUND

In an Ethernet network, a network device such as a network switch or a router screens, by using an access control list (ACL) in most circumstances, packets received by a port of the device to obtain a protocol packet, and sets a committed access rate (CAR) for the obtained protocol packet to limit a rate at which the protocol packet is sent to a central processing unit (CPU), so as to prevent the CPU from receiving excessive packets.

To reduce hardware resources that are used to set the ACL and the CAR, the network device generally uses a same ACL for protocol packets of a same protocol type and that are received by the multiple ports, to perform a same CAR operation. However, if an unauthorized user sends a large quantity of protocol packets of a same protocol type to the network device through a port, which does not exchange a network protocol packet, of the network device, because the multiple ports use a same ACL and CAR, a port that exchanges a network protocol packet cannot process a normal protocol packet of the protocol type, and an effect similar to a denial-of-service (DOS) attack is generated.

To avoid occurrence of the effect similar to a DOS attack, ports of the network device are generally configured to two types: a trusted port and an untrusted port. A port that does not exchange a network protocol packet is configured to an untrusted port, where the untrusted port does not receive a protocol packet. A port that exchanges a network protocol packet is configured to a trusted port, and a CAR at which a protocol packet is received is set for the trusted port. In this way, in a case in which the untrusted port is attacked, processing performed by the trusted port on a normal protocol packet is not affected.

Currently, manual configuration is often required for configuring a trusted port and an untrusted port, which causes heavy workload, and may lead to an incorrect configuration.

### SUMMARY

Embodiments of the present disclosure provide a processing method and apparatus for preventing a packet attack, to reduce incorrect configurations and achieve a relatively good effect for preventing a packet attack.

According to a first aspect, a processing method for preventing a packet attack is provided, including: monitoring a network protocol negotiation status of a port of a network device; setting, according to the detected network protocol negotiation status of the port of the network device, a port that succeeds in network protocol negotiation to a trusted port; selecting, according to a first access control list, a protocol packet from packets received by the trusted port, and limiting, according to a first committed access rate, a rate at which the protocol packet is sent to a central processing unit; setting, according to the detected network protocol negotiation status of the port of the network device, a port that fails in network protocol negotiation to an untrusted port; and selecting, according to a second access control list, a protocol packet from packets received by the untrusted port, and limiting, according to a second committed access rate, a rate at which the protocol packet is sent to the central processing unit.

With reference to the first aspect, in a first implementation manner of the first aspect, after the setting a port that succeeds in network protocol negotiation to a trusted port, the method further includes: monitoring a packet reception rate of the trusted port; and changing the trusted port to an untrusted port in a case in which the packet reception rate exceeds a threshold.

With reference to the first aspect or the first implementation manner of the first aspect, in a second implementation manner of the first aspect, the first access control list is the same as a first access control list used by another trusted port except the trusted port; and the first committed access rate is the same as a first committed access rate used by another trusted port except the trusted port.

With reference to any one of the first aspect, the first implementation manner of the first aspect, and the second implementation manner of the first aspect, in a third implementation manner of the first aspect, the second access control list is the same as a second access control list used by another untrusted port except the untrusted port; and the second committed access rate is the same as a second committed access rate used by another untrusted port except the untrusted port.

With reference to any one of the first aspect and the first implementation manner of the first aspect to the third implementation manner of the first aspect, in a fourth implementation manner of the first aspect, before the monitoring a network protocol negotiation status of a port of a network device, the method further includes setting each port of the network device to an untrusted port.

According to a second aspect, an embodiment of the present disclosure provides a processing apparatus for preventing a packet attack, including: a monitoring unit configured to monitor a network protocol negotiation status of a port of a network device; a setting unit configured to set, to a trusted port, a port that succeeds in network protocol negotiation, and is detected by the monitoring unit; and set, to an untrusted port, a port that fails in network protocol negotiation, and is detected by the monitoring unit; and a processing unit configured to select, according to a first access control list, a protocol packet from packets received by the trusted port set by the setting unit; limit, according to a first committed access rate, a rate at which the protocol packet is sent to a central processing unit; select, according to a second access control list, a protocol packet from packets received by the untrusted port set by the setting unit; and limit, according to a second committed access rate, a rate at which the protocol packet is sent to the central processing unit.

With reference to the second aspect, in a first implementation manner of the second aspect, the monitoring unit is further configured to, after the setting unit sets the port that succeeds in network protocol negotiation to a trusted port, monitor a packet reception rate of the trusted port; and the setting unit is further configured to change the trusted port to an untrusted port in a case in which the monitoring unit detects that the packet reception rate of the trusted port exceeds a threshold.

With reference to the second aspect or the first implementation manner of the second aspect, in a second implementation manner of the second aspect, the first access control list is the same as a first access control list used by another trusted port except the trusted port; and the first committed access rate is the same as a first committed access rate used by another trusted port except the trusted port.

With reference to any one of the second aspect, the first implementation manner of the second aspect, and the second implementation manner of the second aspect, in a third implementation manner of the second aspect, the second access control list is the same as a second access control list used by another untrusted port except the untrusted port; and the second committed access rate is the same as a second committed access rate used by another untrusted port except the untrusted port.

With reference to any one of the second aspect and the first implementation manner of the second aspect to the third implementation manner of the second aspect, in a fourth implementation manner of the second aspect, the setting unit is further configured to, before the monitoring unit monitors the network protocol negotiation status of the port of the network device, set each port of the network device to an untrusted port.

According to a third aspect, an embodiment of the present disclosure provides a network device for preventing a packet attack, including a processor, a memory, a device port, a content-addressable memory, and a forwarding chip, where the memory is configured to store program code executed by the processor; the processor is configured to invoke the program code stored by the memory and perform the following operations according to the program code: monitoring a network protocol negotiation status of the device port; instructing the forwarding chip to set, in the content-addressable memory, a matching item, which matches a device port that succeeds in network protocol negotiation and is detected by the processor, in a first access control list, so as to set the device port that succeeds in network protocol negotiation to a trusted port and select a protocol packet at the trusted port according to the first access control list; and instructing the forwarding chip to set, in the content-addressable memory, a matching item, which matches a device port that fails in network protocol negotiation and is detected by the processor, in a second access control list, so as to set the device port that fails in network protocol negotiation to an untrusted port and select a protocol packet at the untrusted port according to the second access control list; and the forwarding chip is configured to set a first committed access rate for the protocol packet selected at the trusted port that is set in the content-addressable memory; limit, according to the first committed access rate, a rate at which the protocol packet selected at the trusted port is sent to the processor; set a second committed access rate for the protocol packet selected at the untrusted port that is set in the content-addressable memory; and limit, according to the second committed access rate, a rate at which the protocol packet selected at the untrusted port is sent to the processor.

With reference to the third aspect, in a first implementation manner of the third aspect, the processor is further configured to, after the device port that succeeds in network protocol negotiation is set to a trusted port in the content-addressable memory, monitor a packet reception rate of the trusted port; and in a case in which the packet reception rate, detected by the processor, of the device port set to a trusted port exceeds a threshold, instruct the forwarding chip to change, in the content-addressable memory, the trusted port to an untrusted port.

With reference to the third aspect or the first implementation manner of the third aspect, in a second implementation manner of the third aspect, the processor is further configured to, before the processor monitors the network protocol negotiation status of the device port of the network device, instruct the forwarding chip to set each device port of the network device to an untrusted port in the content-addressable memory.

According to the processing method and apparatus for preventing a packet attack that are provided by the embodiments of the present disclosure, a port that succeeds in network protocol negotiation and a port that fails in network protocol negotiation can be determined by monitoring a network protocol negotiation status of a port; and the port that succeeds in network protocol negotiation is set to a trusted port, and the port that fails in network protocol negotiation is set to an untrusted port. Setting of the trusted port and the untrusted port can be completed without using a manner of manual configuration. Therefore, incorrect configurations caused by manual configuration can be reduced, configuration accuracy of the trusted port and the untrusted port can be improved, and a relatively good effect for preventing a packet attack can be achieved.

### BRIEF DESCRIPTION OF DRAWINGS

FIG. 1 is a first implementation flowchart of a processing method for preventing a packet attack according to an embodiment of the present disclosure;

FIG. 2 is a second implementation flowchart of a processing method for preventing a packet attack according to an embodiment of the present disclosure;

FIG. 3A and FIG. 3B are third implementation flowcharts of processing methods for preventing a packet attack according to embodiments of the present disclosure;

FIG. 4 is a schematic composition diagram of a processing apparatus for preventing a packet attack according to an embodiment of the present disclosure; and

FIG. 5 is a schematic composition diagram of a network device for preventing a packet attack according to an embodiment of the present disclosure.

### DESCRIPTION OF EMBODIMENTS

The following clearly describes the technical solutions in the embodiments of the present disclosure with reference to the accompanying drawings in the embodiments of the present disclosure.

A processing method for preventing a packet attack provided in the embodiments of the present disclosure is applicable to a first network device and a second network device that need to perform a process of network protocol negotiation, where the process of network protocol negotiation refers to a process in which a destination routing, a link status, and the like are determined by exchanging network protocol packets, and a network protocol may be a routing protocol, Bidirectional Forwarding Detection (BFD), or the like. The first network device and the second network device are network devices. The network devices may be a network switch, a router, a firewall, and the like. If a network device receives a large quantity of protocol packets through a port that does not exchange a network protocol packet, these protocol packets cannot undergo a network protocol negotiation process. Therefore, in the embodiments of the present disclosure, a port that succeeds in network protocol negotiation is set to a trusted port, and a port that fails in network protocol negotiation is set to an untrusted port, so that setting of the trusted port and the untrusted port can be completed without manual configuration.

Optionally, in the embodiments of the present disclosure, a protocol packet may be selected, according to a first ACL, from packets received by the trusted port, and a first CAR is set for the protocol packet, to limit, according to the first CAR, a rate at which the protocol packet is sent to a CPU. A protocol packet is selected, according to a second ACL, from packets received by the untrusted port, and a second CAR is set for the protocol packet, to limit, according to the second CAR, a rate at which the protocol packet is sent to the CPU. The first ACL is different from the second ACL. For example, a matching item in the first ACL includes a first port group, where the first port group includes port identifiers of all trusted ports; and a matching item in the second ACL includes a second port group, where the second port group includes port identifiers of all untrusted ports. The first CAR is different from the second CAR. For example, a value of the first CAR is greater than a value of the second CAR, which ensures that a protocol packet can be sent to the CPU normally. The value of the second CAR is less than the value of the first CAR, so that the trusted port can be prevented from being attacked in a case in which a large quantity of protocol packets are received by the untrusted port.

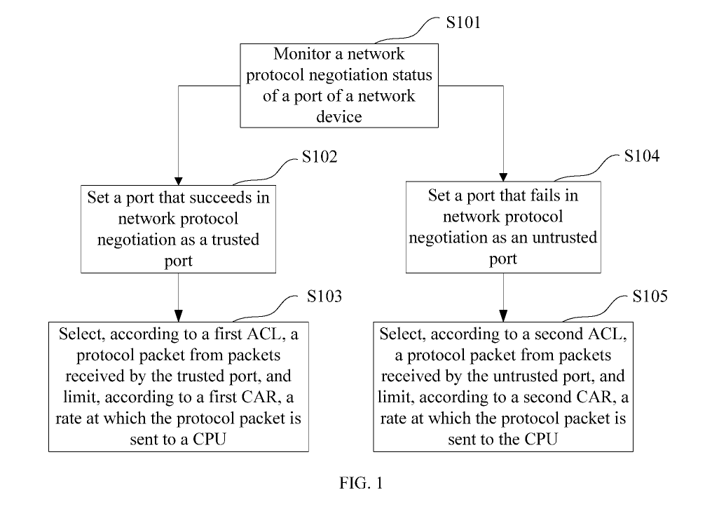

An embodiment of the present disclosure provides a processing method for preventing a packet attack. FIG. 1 shows a flowchart of the processing method for preventing a packet attack according to this embodiment of the present disclosure. As shown in FIG. 1, the processing method for preventing a packet attack provided by this embodiment of the present disclosure includes the following steps:

S101. A network device monitors a network protocol negotiation status of a port of the network device.

For communication between network devices, network protocol negotiation needs to be performed between ports of the two network devices that perform communication with each other. For example, for establishment of the Transmission Control Protocol (TCP) connection, negotiation performed by means of a three-way handshake is often required.

In this embodiment of the present disclosure, the port of the network device that performs communication may be a physical port or may be a logical port.

In this embodiment of the present disclosure, a CPU may monitor the network protocol negotiation status of the port of the network device and perform, according to a monitoring result of the CPU, a step of setting a trusted port or setting an untrusted port.

S102. The network device sets, according to the detected network protocol negotiation status of the port of the network device, a port that succeeds in network protocol negotiation to a trusted port.

S103. The network device selects, according to a first ACL, a protocol packet from packets received by the trusted port, and sets a first CAR for the protocol packet, to limit, according to the first CAR, a rate at which the protocol packet is sent to a CPU.

In this embodiment of the present disclosure, the network device may select, according to the first ACL, a protocol packet from the packets received by all trusted ports of the network device, and limit, according to the first CAR, a rate at which the protocol packet is sent to the CPU. In other words, all the trusted ports in this embodiment of the present disclosure use the same first ACL and the same first CAR.

S104. The network device sets, according to the detected network protocol negotiation status of the port of the network device, a port that fails in network protocol negotiation to an untrusted port.

S105. The network device selects, according to a second ACL, a protocol packet from packets received by the untrusted port, and sets a second CAR for the protocol packet, to limit, according to the second CAR, a rate at which the protocol packet is sent to the CPU.

In this embodiment of the present disclosure, the network device may select, according to the second ACL, a protocol packet from the packets received by all untrusted ports of the network device, and limit, according to the second CAR, a rate at which the protocol packet is sent to the CPU. In other words, all the untrusted ports in this embodiment of the present disclosure use the same second ACL and the same second CAR.

Generally, ports that exchange network protocol packets are required to perform network protocol negotiation to establish communication, and a port that does not exchange a network protocol packet is not required to perform network protocol negotiation. Therefore, in this embodiment of the present disclosure, a port that exchanges a network protocol packet and a port that does not exchange a network protocol packet are differentiated by monitoring a network protocol negotiation status of a port of a network device.

In the processing method for preventing a packet attack provided by this embodiment of the present disclosure, a network device can determine, by monitoring a network protocol negotiation status of a port, a port that succeeds in network protocol negotiation and a port that fails in network protocol negotiation; and the network device sets the port that succeeds in network protocol negotiation to a trusted port, and sets the port that fails in network protocol negotiation to an untrusted port. Setting of the trusted port and the untrusted port can be completed without manual configuration, which reduces incorrect configurations caused by manual configuration and improves configuration accuracy of the trusted port and the untrusted port. In addition, in this embodiment of the present disclosure, the network device selects, according to a first ACL, a protocol packet from packets received by the trusted port, and limits, according to a first CAR, a rate at which the protocol packet is sent to a CPU, where a value of the first CAR is greater than a value of a second CAR, which can ensure that the protocol packet can be sent to the CPU normally. The network device selects, according to a second ACL, a protocol packet from packets received by the untrusted port, and limits, according to the second CAR, a rate at which the protocol packet is sent to the CPU, where the first ACL is different from the second ACL, and the value of the second CAR is less than the value of the first CAR, which can ensure that processing performed by the trusted port on the protocol packet is not affected in a case in which a large quantity of protocol packets are received by the untrusted port.

In this embodiment of the present disclosure, according to the processing method for preventing a packet attack in which all trusted ports of the network device use the first ACL and the first CAR and all untrusted ports of the network device use the second ACL and the second CAR, fewer resources can be used to achieve an objective of preventing normal protocol packet processing performed by a trusted port from being affected when an untrusted port is attacked by a large quantity of protocol packets.

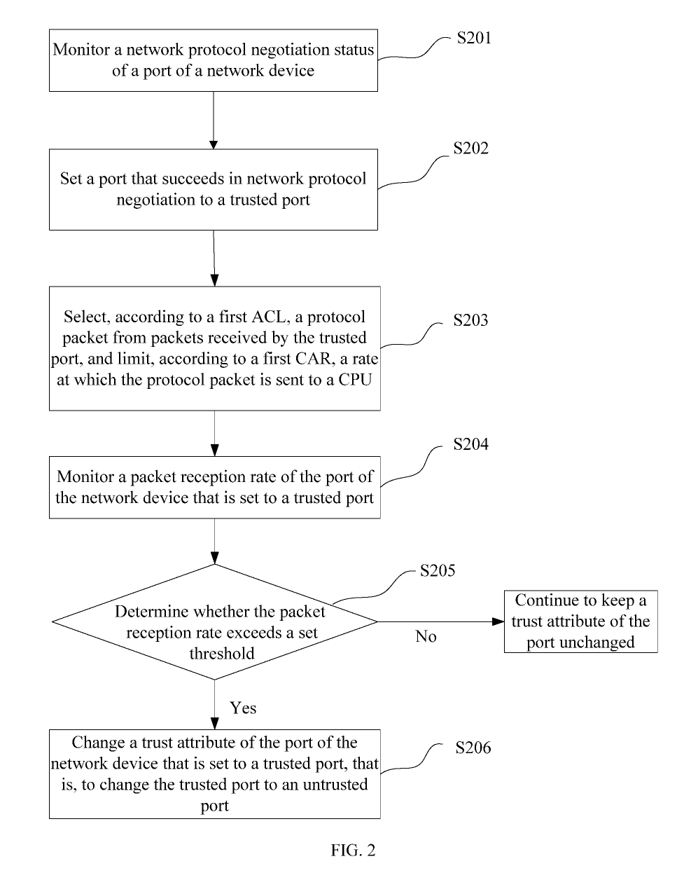

FIG. 2 shows another flowchart of a processing method for preventing a packet attack according to an embodiment of the present disclosure. As shown in FIG. 2, the processing method for preventing a packet attack provided by this embodiment of the present disclosure includes the following steps:

S201. A network device monitors a network protocol negotiation status of a port of the network device.

S202. The network device sets a port that succeeds in network protocol negotiation to a trusted port.

S203. The network device selects, according to a first ACL, a protocol packet from packets received by the trusted port, and limits, according to a first CAR, a rate at which the protocol packet is sent to a CPU.

S204. Monitor a packet reception rate of the port of the network device that is set to a trusted port.

Generally, after network devices succeed in network protocol negotiation, a protocol packet reception rate of a port of the network device should be less than a set threshold, where the set threshold is less than the first CAR and is generally a reference value defined by a standard or a specified reference value that is configured. Therefore, in this embodiment of the present disclosure, the packet reception rate of the trusted port may be monitored. Whether the port of the network device that is set to a trusted port is attacked by a large quantity of protocol packets is determined according to a monitoring result.

S205. Determine whether the packet reception rate of the port of the network device that is set to a trusted port exceeds a set threshold.

In this embodiment of the present disclosure, if the packet reception rate of the port of the network device that is set to a trusted port exceeds the set threshold, it may be considered that the port of the network device that is set to a trusted port is attacked by a large quantity of protocol packets, and a trust attribute of the port of the network device that is set to a trusted port may be changed. If the packet reception rate of the port of the network device that is set to a trusted port is less than the set threshold, a trust attribute of the port of the network device that is set to a trusted port continues to keep unchanged, a protocol packet is selected, according to the first ACL, from the packets received by the trusted port, and a rate at which the protocol packet is sent to the CPU is limited according to the first CAR.

S206. In a case in which the packet reception rate of the port of the network device that is set to a trusted port exceeds the threshold, change a trust attribute of the port of the network device that is set to a trusted port, to change the trusted port to an untrusted port; select, according to a second ACL, a protocol packet from packets received by the untrusted port; and limit, according to a second CAR, a rate at which the protocol packet is sent to the CPU.

In this embodiment of the present disclosure, a matching item in the first ACL includes a first port group, where the first port group includes port identifiers of all trusted ports. A matching item in the second ACL includes a second port group, where the second port group includes port identifiers of all untrusted ports. To change a port of the network device from a trusted port to an untrusted port, the following may be performed: removing a port identifier of the port of the network device from the first port group and adding the port identifier of the port of the network device to the second port group.

In this embodiment of the present disclosure, after the port that succeeds in network protocol negotiation is set to a trusted port, the packet reception rate of the port of the network device that is set to a trusted port is further monitored. In a case in which a port of the network device is configured to a trusted port and a packet reception rate of the port of the network device that is configured to a trusted port exceeds a threshold, a trust attribute of the port of the network device that is set to a trusted port is changed, to change the trusted port to an untrusted port; a protocol packet is selected, according to the second ACL, from packets received by the untrusted port; and a rate at which the protocol packet is sent to the CPU is limited according to the second CAR. In this way, processing performed by another trusted port on a normal protocol packet can be prevented from being affected when excessive protocol packets are received by the port of the network device that is set to a trusted port.

In this embodiment of the present disclosure, after the trusted port is changed to an untrusted port, a packet reception rate of the port of the network device that is changed to an untrusted port may be further monitored in a set period of time. If the packet reception rate continues to be less than a set threshold in the set period of time, the port of the network device that is changed to an untrusted port may be restored to a trusted port; a protocol packet is selected, according to the first ACL, from packets received by the trusted port; and a rate at which the protocol packet is sent to the CPU is limited according to the first CAR, which ensures that the protocol packet is processed normally.

In this embodiment of the present disclosure, the matching item in the first ACL includes the first port group, where the first port group includes the port identifiers of all the trusted ports. The matching item in the second ACL includes the second port group, where the second port group includes the port identifiers of all the untrusted ports. When a port of the network device is changed from an untrusted port to a trusted port, the network device removes a port identifier of the port of the network device from the second port group and adds the port identifier of the port of the network device to the first port group.

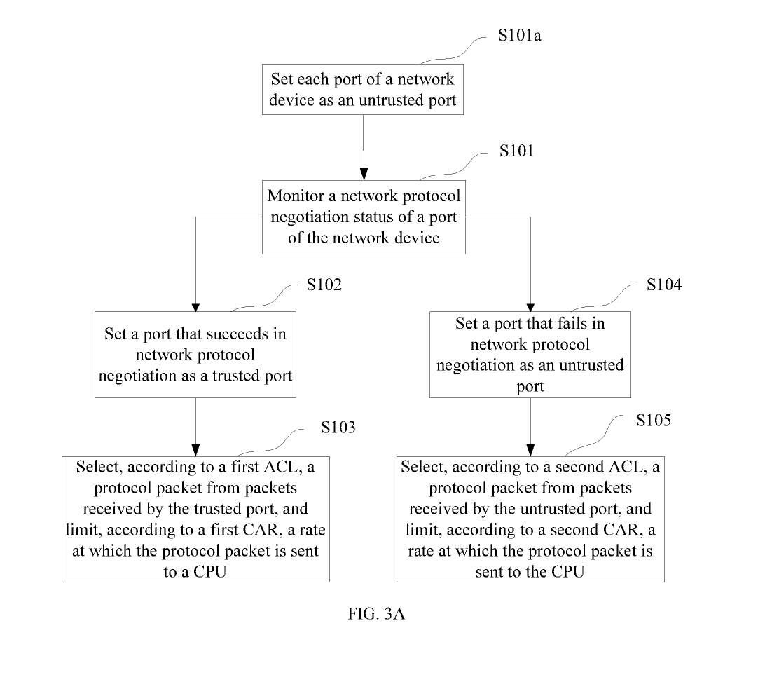

FIG. 3A and FIG. 3B show still another two flowcharts of processing methods for preventing a packet attack according to embodiments of the present disclosure.

On the basis of the method shown in FIG. 1, the processing method for preventing a packet attack shown in FIG. 3A further includes the following step:

S101a. Set each port of a network device to an untrusted port.

On the basis of the method shown in FIG. 2, the processing method for preventing a packet attack shown in FIG. 3B further includes the following step:

S201a. Set each port of a network device to an untrusted port.

In the processing methods for preventing a packet attack shown in FIG. 3A and FIG. 3B according to this embodiment of the present disclosure, each port of the network device is initially set to an untrusted port. The network device selects, according to a second ACL, a protocol packet from packets received by the untrusted port set initially; and sets a second CAR for the protocol packet, to limit, according to the second CAR, a rate at which the protocol packet is sent to a CPU. After it is detected that a port of the network device succeeds in network protocol negotiation, the port that succeeds in network protocol negotiation is set to a trusted port, and for a port that fails in network protocol negotiation, an original trust attribute of an untrusted port continues to keep unchanged, which can ensure that normal processing performed by the trusted port on a protocol packet is not affected when excessive protocol packets are received by another port.

It should be noted that a method for configuring a trusted port and an untrusted port in the processing methods for preventing a packet attack provided by the embodiments of the present disclosure is applicable to any network architecture in which network protocol negotiation occurs, and is not limited to the examples used in the foregoing embodiments. For example, the processing methods for preventing a packet attack provided by the embodiments of the present disclosure is further applicable to a BFD scenario, to implement automatic configuration of a trusted port and an untrusted port and implement automatic switch between a trusted port and a untrusted port, thereby preventing a protocol packet attack dynamically.

It should be further noted that reference numerals of all steps involved in the embodiments of the present disclosure are used only for ease of description, and do not limit an execution sequence of all the steps. For example, step S102 and step S104 in FIG. 1 are not sequentially performed.

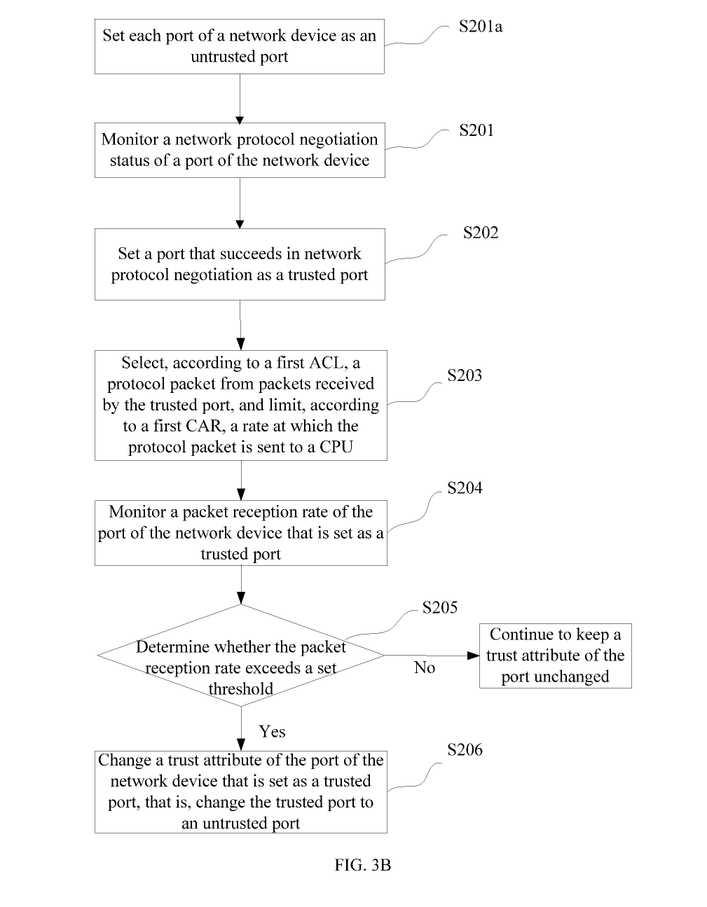

On the basis of the processing methods for preventing a packet attack provided by the foregoing embodiments, an embodiment of the present disclosure further provides a processing apparatus 400 for preventing a packet attack. As shown in FIG. 4, the processing apparatus 400 for preventing a packet attack provided by this embodiment of the present disclosure includes a monitoring unit 401, a setting unit 402, and a processing unit 403, where the monitoring unit 401 is configured to monitor a network protocol negotiation status of a port of a network device; the setting unit 402 is configured to set, to a trusted port, a port that succeeds in network protocol negotiation and is detected by the monitoring unit 401; and set, to an untrusted port, a port that fails in network protocol negotiation and is detected by the monitoring unit 401; and the processing unit 403 is configured to select, according to a first ACL, a protocol packet from packets received by the trusted port set by the setting unit 402; limit, according to a first CAR, a rate at which the protocol packet is sent to a CPU; select, according to a second ACL, a protocol packet from packets received by the untrusted port set by the setting unit 402; and limit, according to a second CAR, a rate at which the protocol packet is sent to the CPU.

In a first implementation manner, the monitoring unit 401 is further configured to, after the setting unit 402 sets the port that succeeds in network protocol negotiation to a trusted port, monitor a packet reception rate of the trusted port.

The setting unit 402 is further configured to change the trusted port to an untrusted port in a case in which the monitoring unit 401 detects that the packet reception rate of the trusted port exceeds a threshold.

The processing unit 403 is further configured to: select, according to the second ACL, a protocol packet from packets received by the untrusted port obtained by changing by the setting unit 402; and limit, according to the second CAR, a rate at which the protocol packet is sent to the central processing unit.

In a second implementation manner, the first ACL is the same as a first ACL used by another trusted port except the trusted port, and the first CAR is the same as a first CAR used by another trusted port except the trusted port.

In a third implementation manner, the second ACL is the same as a second ACL used by another untrusted port except the untrusted port, and the second CAR is the same as a second CAR used by another untrusted port except the untrusted port.

In a fourth implementation manner, the setting unit 402 is further configured to, before the monitoring unit 401 monitors the network protocol negotiation status of the port of the network device, set each port of the network device to an untrusted port.

The processing apparatus 400 for preventing a packet attack provided by this embodiment of the present disclosure may be a network device that performs network protocol negotiation. For example, the network device may be a network switch, a router, or the like, which is not limited in this embodiment of the present disclosure.

The processing apparatus 400 for preventing a packet attack provided by this embodiment of the present disclosure can determine, by monitoring a network protocol negotiation status of a port, a port that succeeds in network protocol negotiation and a port that fails in network protocol negotiation; and set the port that succeeds in network protocol negotiation to a trusted port, and set the port that fails in network protocol negotiation to an untrusted port. Setting of the trusted port and the untrusted port can be completed without using a manner of manual configuration. Therefore, incorrect configurations caused by manual configuration can be reduced, configuration accuracy of the trusted port and the untrusted port can be improved, and a relatively good effect for preventing a packet attack can be achieved by receiving protocol packets at the trusted port and the untrusted port by using different resources.

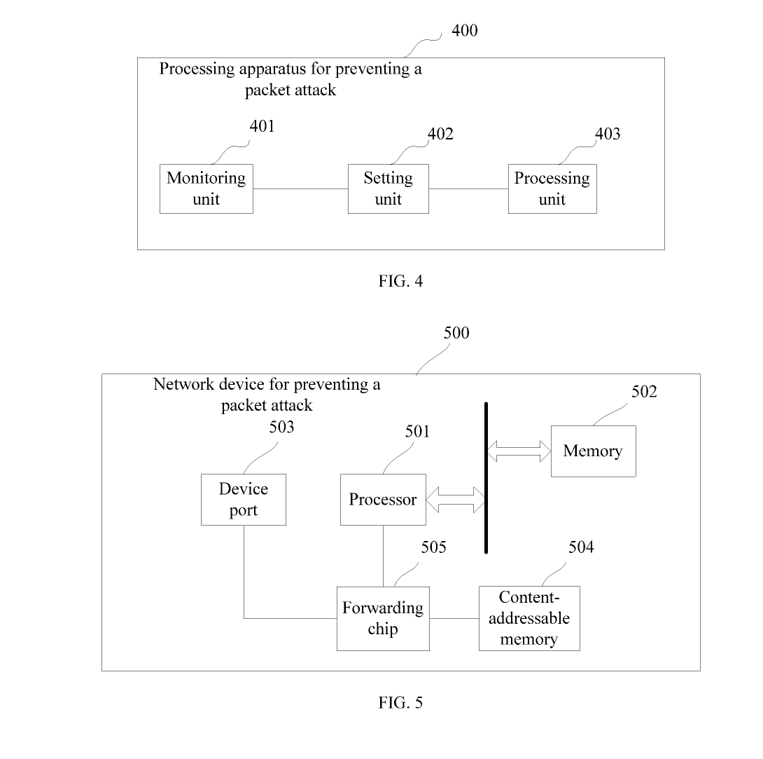

On the basis of the processing method and apparatus for preventing a packet attack provided by the foregoing embodiments, an embodiment of the present disclosure further provides a network device 500 for preventing a packet attack. As shown in FIG. 5, the network device 500 for preventing a packet attack provided by this embodiment of the present disclosure includes a processor 501, a memory 502, a device port 503, a content-addressable memory (CAM) 504, and a forwarding chip 505. Both the forwarding chip 505 and the memory 502 are connected to the processor 501, the forwarding chip 505 is connected to the CAM 504, and the forwarding chip 505 is connected to the device port 503. A specific medium for connecting the foregoing components is not limited in this embodiment of the present disclosure. In FIG. 5 of this embodiment of the present disclosure, the memory 502 and the processor 501 are connected by using a bus, where in FIG. 5, the bus is represented by a bold line; a manner of connecting other components is only exemplarily described and is not limited. For example, the forwarding chip 505 and the processor 501 may be connected by a bus.

The forwarding chip 505 in this embodiment of the present disclosure may be a network processor (NP), an application-specific integrated circuit (ASIC), a programmable logic device (PLD), or a combination thereof The PLD may be a complex programmable logic device (CPLD), a field-programmable gate array (FPGA), a generic array logic (GAL), or a combination thereof The forwarding chip 505 in this embodiment of the present disclosure may set a CAR for a protocol packet to limit a rate at which the protocol packet is sent to the processor 501, so as to prevent the processor 501 from receiving excessive protocol packets.

The CAM 504 in this embodiment of the present disclosure may be, for example, a ternary CAM (TCAM). The CAM 504 in this embodiment of the present disclosure stores an ACL, which is used to perform selection on packets received by the device port 503 to obtain a protocol packet.

The device port 503 in this embodiment of the present disclosure communicates with another device or a communications network by using an apparatus such as a transceiver. The device port 503 in this embodiment of the present disclosure is configured to receive and send a packet.

The memory 502 in this embodiment of the present disclosure is configured to store program code executed by the processor 501, and may be a read-only memory (ROM), or a random access memory (RAM), or may be an electrically erasable programmable read-only memory (EEPROM), a disk storage medium or another magnetic storage device, or any other medium, which can be used to carry or store expected program code which is in a form of an instruction or a data structure, and which can be accessed by a computer, but is not limited thereto. For example, the memory 502 may be a combination of the foregoing memories.

The processor 501 in this embodiment of the present disclosure may be a general-purpose CPU.

In this embodiment of the present disclosure, the network device 500 for preventing a packet attack implements a communication connection to at least one other communication network element by using at least one device port 503, to receive and send a packet, and perform network protocol negotiation with a device port of another communication network element. The CAM 504 selects, according to the stored ACL, a protocol packet from packets received by the device port 503. For example, the CAM 504 may select, as the protocol packet, a packet that matches a port identifier that are in a port group and a protocol type included in matching items in the ACL. The forwarding chip 505 sets a CAR for the protocol packet selected by the CAM 504, to limit a rate at which the protocol packet is sent to the processor 501.

The processor 501 may invoke the program code stored by the memory 502 and perform the following operations according to the program code: monitoring a network protocol negotiation status of the device port 503; instructing the forwarding chip 505 to set, in the CAM 504, a matching item, which matches the device port 503 that succeeds in network protocol negotiation, in a first ACL, so as to set the device port 503 that succeeds in network protocol negotiation to a trusted port and select a protocol packet at the trusted port according to the first ACL; and instructing the forwarding chip 505 to set, in the CAM 504, a matching item, which matches the device port 503 that fails in network protocol negotiation, in a second ACL, so as to set the device port 503 that fails in network protocol negotiation to an untrusted port and select a protocol packet at the untrusted port according to the second ACL.

The first ACL set in the CAM 504 in this embodiment of the present disclosure is the same as a first ACL used by another trusted port except the trusted port that is set currently. The second ACL set in the CAM 504 is the same as a second ACL used by another untrusted port except the untrusted port that is set currently.

The forwarding chip 505 may set a first CAR for the protocol packet selected at the trusted port, to limit, according to the first CAR, a rate at which the protocol packet selected at the trusted port is sent to the processor 501. The forwarding chip 505 sets a second CAR for the protocol packet selected at the untrusted port, to limit, according to the second CAR, a rate at which the protocol packet selected at the untrusted port is sent to the processor 501.

The first CAR set by the forwarding chip 505 in this embodiment of the present disclosure is the same as a first CAR used by another trusted port except the trusted port that is set currently. The second CAR set by the forwarding chip 505 is the same as a second CAR used by another untrusted port except the untrusted port that is set currently.

In a first implementation manner, the processor 501 is further configured to, after the device port 503 that succeeds in network protocol negotiation is set to a trusted port in the CAM 504, monitor a packet reception rate of the trusted port; and in a case in which the processor 501 detects that the packet reception rate of the device port 503 that is set to a trusted port exceeds a threshold, instruct the forwarding chip 505 to change, in the CAM 504, the device port 503 that is set to a trusted port to an untrusted port.

In a second implementation manner, the processor 501 is further configured to, before the processor 501 monitors the network protocol negotiation status of the device port 503 of the network device, instruct the forwarding chip 505 to set, in the CAM 504, each device port 503 of the network device to an untrusted port.

The network device 500 for preventing a packet attack provided by this embodiment of the present disclosure may be a network device that performs network protocol negotiation. For example, the network device may be a network switch, a router, or the like, which is not limited in this embodiment of the present disclosure.

The network device 500 for preventing a packet attack provided by this embodiment of the present disclosure can determine, by monitoring a network protocol negotiation status of a port, a port that succeeds in network protocol negotiation and a port that fails in network protocol negotiation; and set the port that succeeds in network protocol negotiation to a trusted port, and set the port that fails in network protocol negotiation to an untrusted port. Setting of the trusted port and the untrusted port can be completed without using a manner of manual configuration. Therefore, incorrect configurations caused by manual configuration can be reduced, configuration accuracy of the trusted port and the untrusted port can be improved, and a relatively good effect for preventing a packet attack can be achieved by receiving protocol packets at the trusted port and the untrusted port by using different resources.

The processing apparatus 400 for preventing a packet attack and the network device 500 for preventing a packet attack that are provided by the embodiments of the present disclosure can be configured to execute the processing methods for preventing a packet attack that are involved in the embodiments of the present disclosure. Therefore, for a part that is not described in detail and about the processing apparatus 400 for preventing a packet attack and the network device 500 for preventing a packet attack in the embodiments of the present disclosure, reference may be made to description of the related methods and accompanying drawings thereof, and details are not described herein again.

The foregoing descriptions are merely exemplary implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A processing method for preventing a packet attack, comprising:
monitoring a network protocol negotiation status of a port of a network device;
setting, according to the detected network protocol negotiation status of the port of the network device, a port that succeeds in network protocol negotiation to a trusted port;
selecting, according to a first access control list, a protocol packet from packets received by the trusted port;
limiting, according to a first committed access rate, a rate at which the protocol packet is sent to a central processing unit;
setting, according to the detected network protocol negotiation status of the port of the network device, a port that fails in network protocol negotiation to an untrusted port;
selecting, according to a second access control list, a protocol packet from packets received by the untrusted port; and
limiting, according to a second committed access rate, a rate at which the protocol packet is sent to the central processing unit.

2. The method according to claim 1, wherein after setting the port that succeeds in network protocol negotiation to the trusted port, the method further comprises:
monitoring a packet reception rate of the trusted port; and
changing the trusted port to an untrusted port in a case in which the packet reception rate exceeds a threshold.

3. The method according to claim 1, wherein the first access control list is the same as another first access control list used by another trusted port except the trusted port, and wherein the first committed access rate is the same as another first committed access rate used by another trusted port except the trusted port.

4. The method according to claim 1, wherein the second access control list is the same as another second access control list used by another untrusted port except the untrusted port, and wherein the second committed access rate is the same as another second committed access rate used by another untrusted port except the untrusted port.

5. The method according to claim 1, wherein before monitoring the network protocol negotiation status of the port of the network device, the method further comprises setting each port of the network device to the untrusted port.

6. A processing apparatus for preventing a packet attack, comprising:
a monitoring unit configured to monitor a network protocol negotiation status of a port of a network device;
a setting unit coupled to the monitoring unit and configured to:
set, to a trusted port, a port that succeeds in network protocol negotiation and is detected by the monitoring unit; and
set, to an untrusted port, a port that fails in network protocol negotiation and is detected by the monitoring unit; and
a processing unit coupled to the setting unit and configured to:
select, according to a first access control list, a protocol packet from packets received by the trusted port set by the setting unit;
limit, according to a first committed access rate, a rate at which the protocol packet is sent to a central processing unit;
select, according to a second access control list, a protocol packet from packets received by the untrusted port set by the setting unit; and
limit, according to a second committed access rate, a rate at which the protocol packet is sent to the central processing unit.

7. The processing apparatus according to claim 6, wherein the monitoring unit is further configured to monitor a packet reception rate of the trusted port after the setting unit sets the port that succeeds in network protocol negotiation to a trusted port, and wherein the setting unit is further configured to change the trusted port to an untrusted port in a case in which the monitoring unit detects that the packet reception rate of the trusted port exceeds a threshold.

8. The processing apparatus according to claim 6, wherein the first access control list is the same as another first access control list used by another trusted port except the trusted port, and wherein the first committed access rate is the same as another first committed access rate used by another trusted port except the trusted port.

9. The processing apparatus according to claim 6, wherein the second access control list is the same as another second access control list used by another untrusted port except the untrusted port, and wherein the second committed access rate is the same as another second committed access rate used by another untrusted port except the untrusted port.

10. The processing apparatus according to claim 6, wherein the setting unit is further configured to set each port of the network device to an untrusted port before the monitoring unit monitors the network protocol negotiation status of the port of the network device.

11. A network device for preventing a packet attack, comprising a processor;
at least one device port;
a content-addressable memory;
a forwarding chip; and
a memory configured to store program code executed by the processor,
wherein the processor is configured to:
monitor a network protocol negotiation status of the at least one device port;
instruct the forwarding chip to set, in the content-addressable memory, a matching item, which matches a first device port that succeeds in network protocol negotiation and is detected by the processor, in a first access control list, so as to set the first device port that succeeds in the network protocol negotiation to a trusted port and select a protocol packet at the trusted port according to the first access control list; and
instruct the forwarding chip to set, in the content-addressable memory, a matching item, which matches a second device port that fails in the network protocol negotiation and is detected by the processor, in a second access control list, so as to set the second device port that fails in the network protocol negotiation to an untrusted port and select the protocol packet at the untrusted port according to the second access control list, and wherein the forwarding chip is configured to:
set a first committed access rate for the protocol packet selected at the trusted port that is set in the content-addressable memory;
limit, according to the first committed access rate, a rate at which the protocol packet selected at the trusted port is sent to the processor;
set a second committed access rate for the protocol packet selected at the untrusted port that is set in the content-addressable memory; and
limit, according to the second committed access rate, a rate at which the protocol packet selected at the untrusted port is sent to the processor.

12. The network device according to claim 11, wherein the processor is further configured to:
monitor a packet reception rate of the trusted port after the first device port that succeeds in the network protocol negotiation is set to the trusted port in the content-addressable memory; and
instruct the forwarding chip to change, in the content-addressable memory, the trusted port to the untrusted port when the packet reception rate of the first device port set to the trusted port, detected by the processor, exceeds a threshold.

13. The network device according to claim 11, wherein the first access control list is the same as another first access control list used by another trusted port except the trusted port, and wherein the first committed access rate is the same as another first committed access rate used by another trusted port except the trusted port.

14. The network device according to claim 11, wherein the second access control list is the same as another second access control list used by another untrusted port except the untrusted port, and the second committed access rate is the same as another second committed access rate used by another untrusted port except the untrusted port.

15. The network device according to claim 11, wherein the processor is further configured to instruct the forwarding chip to set each of the at least one device port of the network device to the untrusted port in the content-addressable memory before the processor monitors the network protocol negotiation status of the at least one device port of the network device.
